(19) United States
(12) Patent Application Publication
(10) Pub. No.: US 2026/0143343 A1
(43) Pub. Date: May 21, 2026

(54) METHOD AND APPARATUS FOR DEVICE VALIDATION IN WIRELESS LOCAL AREA NETWORK

(71) Applicant: Nokia Technologies Oy, Espoo (FI)

(72) Inventors: Orhan Okan MUTGAN, Munich (DE); Jian Guo LIU, Shanghai (CN); Zhi Jie YANG, Shanghai (CN); Yi Ming JIANG, Shanghai (CN); Ding Jun HE, Shanghai (CN)

(21) Appl. No.: 19/122,409

(22) PCT Filed: Oct. 24, 2022
(86) PCT No.: PCT/CN2022/127160

§ 371 Date: Apr. 18, 2025

(51) Int. Cl. H04W 12/106; H04W 12/037; H04W 84/12

(52) U.S. Cl. CPC H04W 12/106; H04W 12/037; H04W 84/12

(57) ABSTRACT

Embodiments of the present disclosure provide a method and an apparatus for a method (60) performed by a first apparatus. The method (60) may comprise: obtaining (S602) an identification information for the first apparatus, during a first association with a second apparatus; determining (S604) one or more parameters for validation, during the first association; determining (S606) a first validation information based at least on the one or more parameters; and transmitting (S608) a first message for a second association with the second apparatus. The first message includes the identification information for the first apparatus and the first validation information. A validation information of an apparatus may be provided in a frame. Thus, an illegal apparatus may be further distinguished.

### TECHNICAL FIELD

Various example embodiments relate generally to the technology of communication, and in particular to a method and an apparatus for device validation in wireless local area network.

### BACKGROUND

This section introduces aspects that may facilitate better understanding of the present disclosure. Accordingly, the statements of this section are to be read in this light and are not to be understood as admissions about what is in the prior art or what is not in the prior art.

In a wireless communication network (such as in a wireless local area network), a communication apparatus (such as a non access point station, non-AP STA) may access the network via another communication apparatus (such as an access point, AP), so as to obtain various service.

The communication between the non-AP STA and the AP is desired to be secured. However, in some scenarios, an attacker will try to pretend to be a legitimate non-AP STA, or an AP. Particularly, the attacker will obtain device identification information of a non-AP STA, or an AP, since some times they have to be transmitted without encryption or they might be intercepted and decrypted. Then, the attack will be performed by utilizing identification information of the legitimate non-AP STA or AP. It is hard for the device in the network to distinguish such attack from normal communications.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

Certain aspects of the present disclosure and their embodiments may provide solutions to these or other challenges. There are, proposed herein, various embodiments which address one or more of the issues disclosed herein. Specific method and apparatus for device validation in wireless local area network may be provided, so as to improve the privacy and security of wireless network.

A first aspect of the present disclosure provides a method performed by a first apparatus. The method may comprise: obtaining an identification information for the first apparatus, during a first association with a second apparatus; determining one or more parameters for validation, during the first association; determining a first validation information based at least on the one or more parameters; and transmitting a first message for a second association with the second apparatus. The first message includes the identification information for the first apparatus and the first validation information.

In exemplary embodiments of the present disclosure, the identification information comprises at least one of: an identifier, ID, or a random media access control address, RMA.

In exemplary embodiments of the present disclosure, the one or more parameters for validation comprises at least one of: a secret key shared by the first apparatus and the second apparatus, a first initial frame number value and a second initial frame number value. The first initial frame number value is the same as the second initial frame number value, or is different than the second initial frame number value. The first initial frame number value is for frames sent from the first apparatus to the second apparatus, and the second initial frame number value is for frames sent from the second apparatus to the first apparatus.

In exemplary embodiments of the present disclosure, at least one of the first and second initial fame number value has a fixed value, and is shared between the first apparatus and the second apparatus privately; or at least one of the first and second initial frame number value has a random value, and is shared publicly.

In exemplary embodiments of the present disclosure, the first validation information comprises a first frame number value and a first validation check field. The first apparatus runs a first counter to determine the first frame number value, based on the first initial frame number value and a number of frames transmitted from the first apparatus to the second apparatus before the first message, or the first initial frame number value and the number of frames exchanged by the first apparatus and the second apparatus before the first message. The first validation check field is determined based at least on the secret key, using a formula shared between the first apparatus and the second apparatus.

In exemplary embodiments of the present disclosure, the first validation check field is determined further based on the first frame number value.

In exemplary embodiments of the present disclosure, the first validation check field is determined further based on additional data related to at least one of the first message, the first apparatus, or the second apparatus. The additional data comprises at least one of: public information, private information. The public information comprises at least one of: a field in media access control header, a public key, a public ID, a random number, or a public signature. The private information comprises at least one of: a private key, a private ID, a private signature, or a random number.

In exemplary embodiments of the present disclosure, the first frame number value and the first validation information are encrypted in the first message.

In exemplary embodiments of the present disclosure, the first message comprises a unicast management frame, or a broadcast management frame.

In exemplary embodiments of the present disclosure, the first message comprises at least one of: probe request, authentication frame sent from first apparatus, association request, or action frames.

In exemplary embodiments of the present disclosure, the action frames may be such as public action frame, FTM request, etc.

In some embodiments, the 4-way handshake frames may not carry validation information.

In exemplary embodiments of the present disclosure, the method may further comprise: receiving, a second message including an identification information for the first and/or second apparatus and a second validation information. The second validation information comprises a second frame number value and a second validation check field.

In exemplary embodiments of the present disclosure, the method may further comprise: determining a third frame number value and a third validation check field; comparing the third frame number value with the second frame number value, and the third validation check field with the second validation check field; and determining that the second message is from an attacker, based on at least one of: whether the third frame number value is larger than the second frame number value, wherein the third frame number value is determined based on a frame number value successfully received in a previous frame; whether the third frame number value is not equal to the second frame number value, wherein the third frame number value is determined based on the second initial frame number value and a number of frames exchanged by the first apparatus and the second apparatus before the second message; or whether the third validation check field is not equal to the second validation check field. The third frame number value is determined by the first counter based on a frame number value successfully received in a previous frame, or the second initial frame number value and a number of frames exchanged by the first apparatus and the second apparatus before the first message. The third validation check field is determined based on at least one of: the secret key or the third frame number value, using a formula shared between the first apparatus and the second apparatus.

In exemplary embodiments of the present disclosure, the second frame number value and the second validation information are encrypted in the second message.

In exemplary embodiments of the present disclosure, the second message comprises a unicast management frame.

In exemplary embodiments of the present disclosure, the second message comprises at least one of: probe response, authentication frame sent from second apparatus, association response, or action frames.

In exemplary embodiments of the present disclosure, the action frames may be such as public action frame, FTM request, etc.

In some embodiments, the 4-way handshake frames may not carry validation information.

In exemplary embodiments of the present disclosure, the first apparatus comprises a non access point station, non-AP STA, or an access point, AP, in a wireless local area network operating according to a standard of 802.11. The second apparatus comprises an AP, or a non-AP STA, in the wireless local network.

A second aspect of the present disclosure provides a method performed by a second apparatus. The method may comprise: obtaining an identification information for a first apparatus, during a first association with the first apparatus; determining one or more parameters for validation, during the first association; and receiving a first message for a second association with the first apparatus. The first message includes the identification information for the first apparatus and a first validation information.

In exemplary embodiments of the present disclosure, the identification information comprises at least one of: an identifier, ID, or a random media access control address, RMA.

In exemplary embodiments of the present disclosure, the one or more parameters for validation comprises at least one of: a secret key shared by the first apparatus and the second apparatus, a first initial frame number value and a second initial frame number value. The first initial frame number value is the same as the second initial frame number value, or is different than the second initial frame number value. The first initial frame number value is for frames sent from the first apparatus to the second apparatus, and the second initial frame number value is for frames sent from the second apparatus to the first apparatus.

In exemplary embodiments of the present disclosure, at least one of the first and second initial fame number value has a fixed value, and is shared between the first apparatus and the second apparatus privately; or at least one of the first and second initial frame number value has a random value, and is shared publicly.

In exemplary embodiments of the present disclosure, the first validation information comprises a first frame number value and a first validation check field.

In exemplary embodiments of the present disclosure, the method may further comprise: determining a fourth frame number value and a fourth validation check field; comparing the fourth frame number value with the first frame number value, and the fourth validation check field with the first validation check field; and determining that the first message is from an attacker, based on at least one of: whether the fourth frame number value is larger than the first frame number value, wherein the fourth frame number value is determined based on a frame number value successfully received in a previous frame; whether the fourth frame number value is not equal to the first frame number value, wherein the fourth frame number value is determined based on the first initial frame number value and a number of frames exchanged by the first apparatus and the second apparatus before the first message; or whether the fourth validation check field is not equal to the first validation check field. The fourth frame number value is determined by a second counter based on a frame number value successfully received in a previous frame, or the first initial frame number value and a number of frames exchanged by the first apparatus and the second apparatus before the first message. The fourth validation check field is determined based at least on the secret key, using a formula shared between the first apparatus and the second apparatus.

In exemplary embodiments of the present disclosure, the fourth validation check field is determined further based on the fourth frame number value.

In exemplary embodiments of the present disclosure, the fourth validation check field is determined further based on additional data related to at least one of: the first message, the first apparatus, or the second apparatus. The additional data comprises at least one of: public information, private information. The public information comprises at least one of: a field in media access control header, a public key, a public ID, a random number, or a public signature. The private information comprises at least one of: a private key, a private ID, a private signature, or a random number.

In exemplary embodiments of the present disclosure, the first frame number value and the first validation information are encrypted in the first message.

In exemplary embodiments of the present disclosure, the first message comprises a unicast management frame, or a broadcast management frame.

In exemplary embodiments of the present disclosure, the first message comprises at least one of: probe request, authentication frame sent from the first apparatus, association request, or action frames.

In exemplary embodiments of the present disclosure, the method may further comprise: transmitting, a second message including an identification information for the first and/or second apparatus and a second validation information. The second validation information comprises a second frame number value and a second validation check field. The second apparatus runs a second counter to determine the second frame number value, based on the second initial frame number value and a number of frames transmitted from the second apparatus to the first apparatus before the second message, or the second initial frame number value and a number of frames exchanged by the first apparatus and the second apparatus before the second message. The second validation check field is determined based on at least one of the secret key, or the second frame number value, using a formula shared between the first apparatus and the second apparatus.

In exemplary embodiments of the present disclosure, the second frame number value and the second validation information are encrypted in the second message.

In exemplary embodiments of the present disclosure, the second message comprises a unicast management frame, or a broadcast management frame.

In exemplary embodiments of the present disclosure, the second message comprises at least one of: probe response, authentication frame sent from the second apparatus, association response or action frames.

In exemplary embodiments of the present disclosure, the first apparatus comprises a non access point station, non-AP STA, or an access point, AP, in a wireless local area network operating according to a standard of 802.11. The second apparatus comprises an AP, or a non-AP STA, in the wireless local network.

A third aspect of the present disclosure provides a first apparatus comprising means configured for: obtaining an identification information for the first apparatus, during a first association with a second apparatus; determining one or more parameters for validation, during the first association; determining a first validation information based at least on the one or more parameters; and transmitting a first message for a second association with the second apparatus. The first message includes the identification information for the first apparatus and the first validation information.

In exemplary embodiments of the present disclosure, the means are further configured for performing the method according any of the embodiments in the first aspect.

In exemplary embodiments of the present disclosure, the means comprise: at least one processor; and at least one memory storing instructions that, when executed by the at least one processor, cause the performance of the first apparatus.

A fourth aspect of the present disclosure provides a second apparatus comprising means configured for: obtaining an identification information for a first apparatus, during a first association with the first apparatus; determining one or more parameters for validation, during the first association; and receiving a first message for a second association with the first apparatus. The first message includes the identification information for the first apparatus and a first validation information.

In exemplary embodiments of the present disclosure, the means are further configured for performing the method according any of the embodiments in the second aspect.

In exemplary embodiments of the present disclosure, the means comprise: at least one processor; and at least one memory storing instructions that, when executed by the at least one processor, cause the performance of the second apparatus.

A fifth aspect of the present disclosure provides a computer-readable storage medium storing instructions, which when executed by at least one processor of a first apparatus, cause the at least one processor of the first apparatus to perform the method according to any of the embodiments of the first aspect; or when executed by at least one processor of a second apparatus, cause the at least one processor of the second apparatus to perform the method according to any of the embodiments of the second aspect.

Embodiments herein afford many advantages. According to embodiments of the present disclosure, an improved manner for device validation in wireless local area network may be provided. A validation information of an apparatus may be provided in a frame. Thus, an illegal apparatus may be further distinguished.

Particularly, the validation information is generated based on one or more specific parameters for validation which are determined during a first association between a first apparatus and a second apparatus. Therefore, it is hard for an attacker to pretend to be the first or second apparatus in other association procedures.

### BRIEF DESCRIPTION OF DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1 is a diagram showing existing identification method for non-AP STA and/or AP using RMA in 802.11 standard.

FIG. 2 is a diagram showing a procedure for replay attack.

FIG. 3 is a diagram showing a procedure for Evil Twin Attack.

FIG. 4 is a diagram showing manners for an attacker to obtain legitimate non-AP STA's and AP's device identification information (e.g., ID or RMA).

FIG. 5 is a diagram showing the attacker acting as the non-AP STA or the AP.

FIG. 6a is a flow chart showing a method performed by a first apparatus, according to exemplary embodiments of the present disclosure.

FIG. 6b is a flow chart illustrating additional steps of the method performed by the first apparatus, in accordance with some embodiments of the present disclosure.

FIG. 7a is a flow chart showing a method performed by a second apparatus, according to exemplary embodiments of the present disclosure.

FIG. 7b is a flow chart illustrating additional steps of the method performed by the second apparatus, in accordance with some embodiments of the present disclosure.

FIG. 7c is a flow chart illustrating additional steps of the method performed by the second apparatus, in accordance with some embodiments of the present disclosure.

FIG. 8a is a block diagram showing an exemplary structure for the first apparatus, according to exemplary embodiments of the present disclosure.

FIG. 8b is a block diagram showing an exemplary structure for the second apparatus, according to exemplary embodiments of the present disclosure.

FIG. 9 is a block diagram showing an apparatus/computer readable storage medium, according to embodiments of the present disclosure.

FIG. 10a is a block diagram showing exemplary apparatus units for the first apparatus, which is suitable for performing the method according to embodiments of the disclosure.

FIG. 10b is a block diagram showing exemplary apparatus units for the second apparatus, which is suitable for performing the method according to embodiments of the disclosure.

FIG. 11 is a diagram showing a proposed Information element (Validation Information Element (VIE)) usage and validating if the frames come from the validated STA or an attacker.

FIG. 12 is a diagram showing an example of Validation Information Element (VIE) and its fields-Frame Number (FN) and Validation Check (VC).

FIG. 13a is a diagram showing an example for Validation Information Element (VIE) Definition, according to embodiments of the present disclosure.

FIG. 13b is a diagram showing an example for Validation Information Element (VIE) Format, according to embodiments of the present disclosure.

FIG. 14 is a diagram showing the proposed Validation Information Element (VIE) in Probe Request, according to embodiments of the present disclosure.

FIG. 15 is a diagram showing an example scenario to construct VIE.

FIG. 16 is a diagram showing an example scenario of VIE [FN, VC] usage and attacker detection, according to embodiments of the present disclosure.

FIG. 17a is a diagram showing a first example scenario about the increasement of the frame number value.

FIG. 17b is a diagram showing a second example scenario about the increasement of the frame number value.

FIG. 17c is a diagram showing a third example scenario about the increasement of the frame number value.

FIG. 17d is a diagram showing a fourth example scenario about the increasement of the frame number value.

FIG. 17e is a diagram showing a fifth example scenario about the increasement of the frame number value.

### DETAILED DESCRIPTION

The embodiments of the present disclosure are described in detail with reference to the accompanying drawings. It should be understood that these embodiments are discussed only for better understand, rather than limitations on the scope of the present disclosure. The described features, advantages, and characteristics of the disclosure may be combined in any suitable manner in one or more embodiments.

Generally, all terms used herein are to be interpreted according to their ordinary meaning in the relevant technical field, unless a different meaning is clearly given and/or is implied from the context in which it is used. The steps of any methods disclosed herein do not have to be performed in the exact order disclosed, unless clearly given and/or implied from the context. Any feature of any of the embodiments disclosed herein may be applied to any other embodiment, wherever appropriate.

As used herein, the term “network” or “communication network” refers to a network following any suitable communication standards (such for an internet network, or any wireless network). For example, wireless communication standards may comprise WLAN, new radio (NR), long term evolution (LTE), LTE-Advanced, etc. In the following description, the terms “network” and “system” can be used interchangeably.

The term “communication apparatus” refers to any end device that can access a communication network and receive services therefrom. By way of example and not limitation, the communication apparatus refers to a mobile terminal, user equipment (UE), or other suitable devices. The communication apparatus may include, but not limited to, a mobile phone, a cellular phone, a smart phone, a wearable device, a vehicle-mounted wireless terminal device, a vehicle, and the like.

As one example, a communication apparatus may represent a device configured for communication in accordance with one or more communication standards promulgated by the Institute of Electrical an Electronics Engineers, IEEE, such as any 802.11 standard, or promulgated by any other organization, such as 3^{rd} generation partnership project, 3GPP.

As yet another example, in an Internet of Things (IoT) scenario, a communication apparatus may represent a machine or other device that performs monitoring and/or measurements, and transmits the results of such monitoring and/or measurements to another terminal device and/or network equipment. Particular examples of such machines or devices are sensors, metering devices such as power meters, industrial machinery, or home or personal appliances, for example refrigerators, televisions, personal wearables such as watches etc. In other scenarios, a communication apparatus may represent a vehicle or other equipment that is capable of monitoring and/or reporting on its operational status or other functions associated with its operation.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

An application scenario in an 802.11 network will be illustrated below, only as one example without limitation.

As illustrative examples but not limitation, embodiments of the present disclosure may be relevant to privacy enhancement for 802.11bi and 802.11bh series standards, especially focusing on replay&evil twin attack and user validation for devices using Random MAC Address (RMA).

In conventional 802.11 standards, the STAs use the fixed unencrypted MAC address in frame headers, which causes a security concern by allowing others to track STAs based on their MAC address. To prevent the STA from being tracked and improve the privacy and privacy of 802.11, MAC address randomization (i.e., Random and Changing MAC (RCM)) became a common technique. Within this regard, 802.11bh and 802.11bi groups focus on identification of STAs using RMA without decreasing user privacy.

802.11bh focuses on device (i.e., non-AP STA) identification through MAC Randomization in pre-association phase, while device (i.e., non-AP STA) still doesn't change MAC address after association (i.e., post-association). On the other hand, IEEE 802.11bi will address privacy concerns as a part of its work and manage to solve the case where non-AP STA can also change its MAC address after association. Note that non-AP STA is abbreviated as STA in this disclosure.

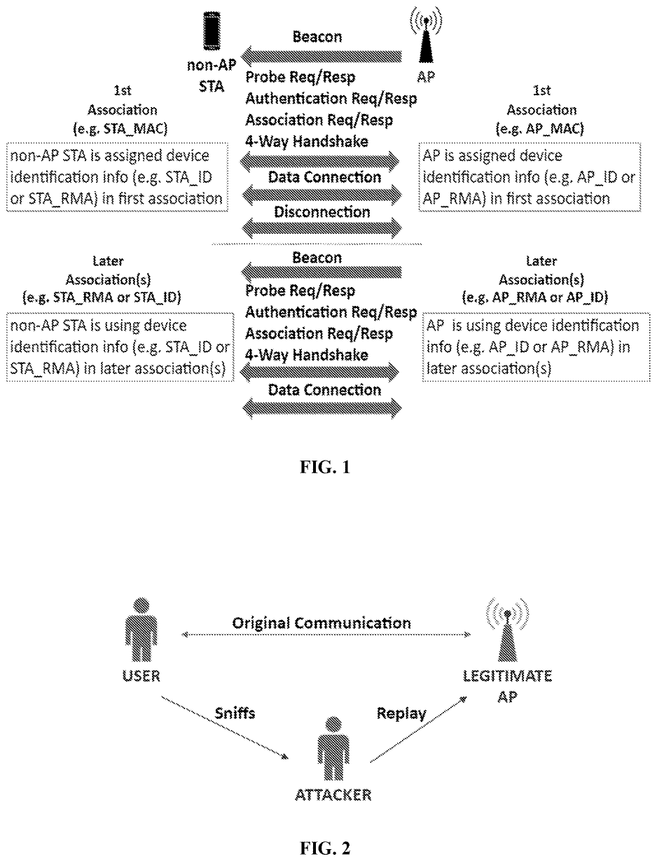

FIG. 1 is a diagram showing existing identification method for non-AP STA and/or AP using RMA in 802.11 standard.

As shown in FIG. 1, non-AP STA and/or AP obtains a device identification information (e.g., ID or an RMA) in first association, and uses that assigned device identification information (e.g., ID or an RMA) in later association(s).

To identify a non-AP STA with RMA, there are several proposals [22/187r2, 22/925r2, 22/895r1, 22/888r2, 22/158r3] in 802.11bh and [22/114r3] in 802.11bi. Basically, the proposed mechanisms assign a device identification information (e.g., ID or an RMA) to the non-AP STA when non-AP STA first associates with the AP, then the non-AP STA uses the assigned device identification information (e.g., ID or an RMA) in later association(s) as shown in FIG. 1. Specifically, non-AP STA is using STA_MAC in its first association. After STA associates with the AP with STA_MAC, it is assigned a device identification information (e.g., ID or an RMA, depending on the identification method). After the non-AP STA disconnects and associates with AP again (later association), it uses previously assigned (e.g., from first association) device identification information (e.g., ID or an RMA) (depending on the identification method), therefore gets identified by the AP.

The 1^{st} association may relate to procedure for probe messages, authentication messages, association messages, 4-way handshake, data connection, disconnection, after the non-AP STA receiving beacon from an AP. Such messages may be any kind of frames, and may be used for request or response, or etc.

The later association may relate to procedure for other probe messages, authentication messages, association messages, 4-way handshake, data connection, after the non-AP STA receiving beacon from an AP.

It is noted that non-AP STA and/or AP might be assigned with multiple device identification information (e.g., multiple IDs or multiple RMAs) in one association (e.g., first association), and use at least one of them in later association(s) (e.g., second association).

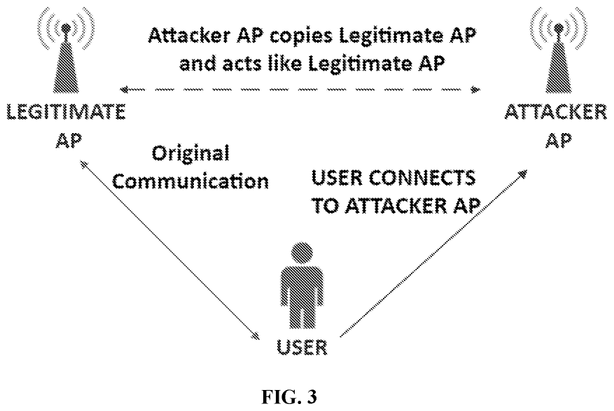

FIG. 2 is a diagram showing a procedure for replay attack.

As shown in FIG. 2, an attacker intercepts (e.g., listens) the secure channel, copies the packets/frames from the user, sends them to network to manipulate.

A replay attack happens when an attacker listens (i.e., sniffs) a secure network communication (i.e., the original communication between a user and a legitimate AP), intercepts it, and then delays or resends (i.e., replays) the packets to misdirect the receiver (e.g., network). It is noted that a hacker doesn't even need to decrypt a packet after capturing it from the network. The attack could be successful simply by resending the whole thing (captured packets).

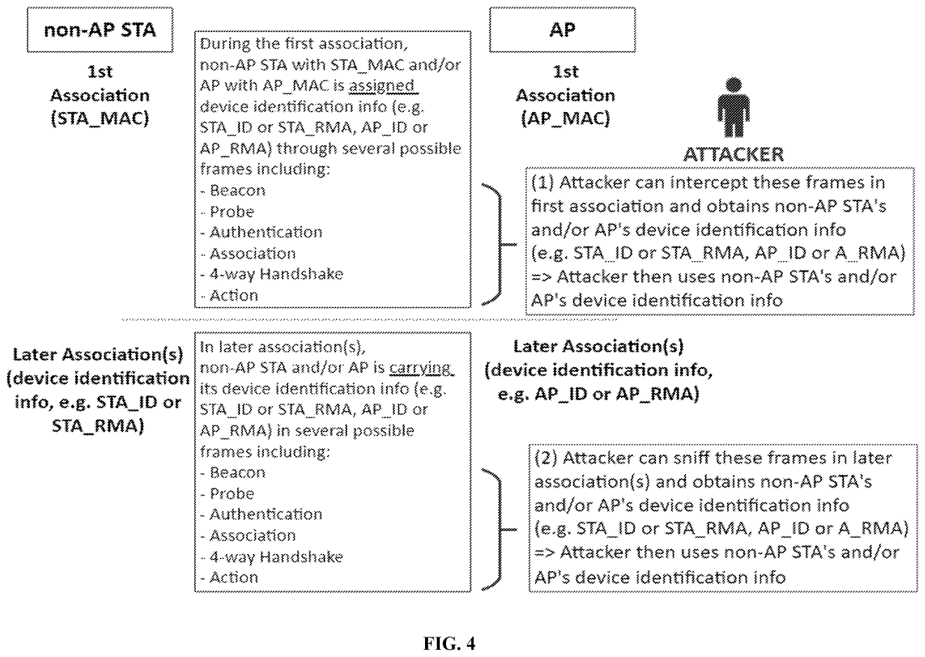

FIG. 3 is a diagram showing a procedure for Evil Twin Attack.

As shown in FIG. 3, an attacker AP listens and copies a legitimate AP, and acts like legitimate AP to trick user to connect to itself. An evil twin attack works by tricking users into connecting to a fake Wi-Fi (Wireless Fidelity) access point that mimics a legitimate network. To do that, an attacker sets up a Wi-Fi AP by copying SSID (Service Set Identifier) and/or BSSID (Basic Service Set Identifier) as a nearby legitimate Wi-Fi network. The attacker might perform a DOS (Denial of Service) attack on the legitimate access point which will cause it to go offline. From then on, the original communication between the user and the legitimate AP will fail, and then user (i.e., clients) would connect to the attacker AP (i.e., fake access point) automatically.

Therefore, some problems might exist.

RMA Identification methods described above have a similar logic: legitimate non-AP STA and/or AP (referred to non-AP STA herein) is assigned a device identification information (e.g., ID or RMA) in an association (e.g., first association), and non-AP STA and/or AP uses that assigned device identification information (e.g., ID or RMA) in subsequent association (e.g., second association). In other words, non-AP STA and/or AP uses a pre-assigned device identification information (e.g., ID or RMA) (i.e., in current association, non-AP STA and/or AP is using device identification information (e.g., ID or RMA) assigned from previous association). It is noted that non-AP STA and/or AP might be assigned with multiple device identification information (e.g., multiple IDs or multiple RMAs) in one association (e.g., first association), and use at least one of them in later association(s) (e.g., second association). Embodiments of the present disclosure does not differentiate single device identification information or multiple device identification information, that is, the proposed solution in embodiments may cover single device identification information and multiple device identification information cases. For simplicity, both cases (single and multiple device identification information) are referred to as same in this disclosure.

This method (i.e., using pre-assigned device identification information) raises some concerns regarding replay and evil twin attacks such that an attacker might obtain the device identification information (e.g. ID or RMA) of the non-AP STA and/or AP, and use (copy) that device identification information (e.g. ID or RMA) to impersonate the non-AP STA or AP. It is noted that pre-association frames (probe, authentication, association, action, and part of 4-way HS) are generally not protected well because non-AP STA and AP does not have security association when sending these frames, therefore these frames are more susceptible to attacks.

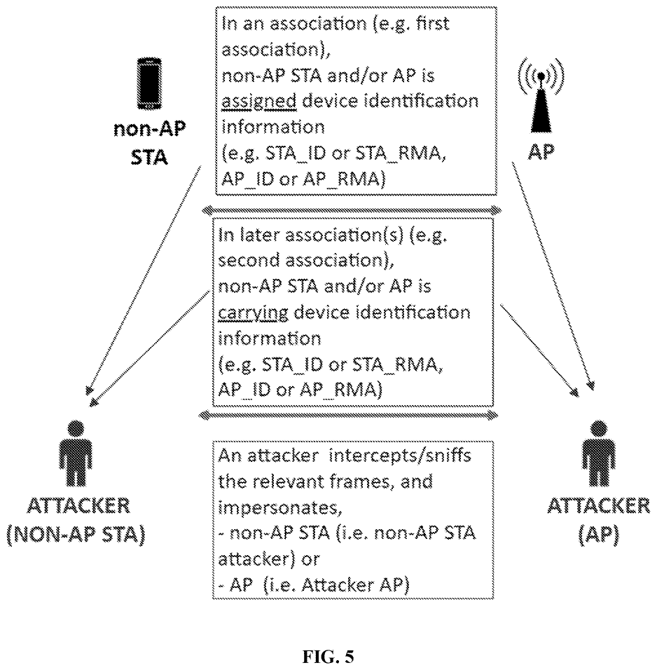

FIG. 4 is a diagram showing manners for an attacker to obtain legitimate non-AP STA's and/or AP's device identification information (e.g., ID or RMA).

As shown in FIG. 4, obtaining that device identification information (e.g., ID or RMA) might happen through some ways including the following.

(1) An attacker intercepts the frames, in which device identification information (e.g., ID or RMA) is assigned to the legitimate non-AP STA and/or AP. There might be several possible frames, in which the non-AP STA and/or AP is assigned device identification information (e.g., ID or RMA), including Probe Messages, Authentication Messages, Association Messages or 4-way Handshake during an association (e.g., first association). The attacker might intercept any of these frames and obtains the non-AP STA's and/or AP's device identification information (e.g., ID or RMA).

(2) An attacker listens (sniffs) the frames, in which the legitimate non-AP STA and/or AP sends device identification information (e.g., ID or RMA) to/from the AP. There might be several possible frames, in which the STA and/or AP carries device identification information (e.g., ID or RMA), including Probe Messages, Authentication Messages, Association Messages or 4-way Handshake in later association(s). The attacker might sniff any of these frames and obtains the non-AP STA's and/or AP's device identification information (e.g., ID or RMA).

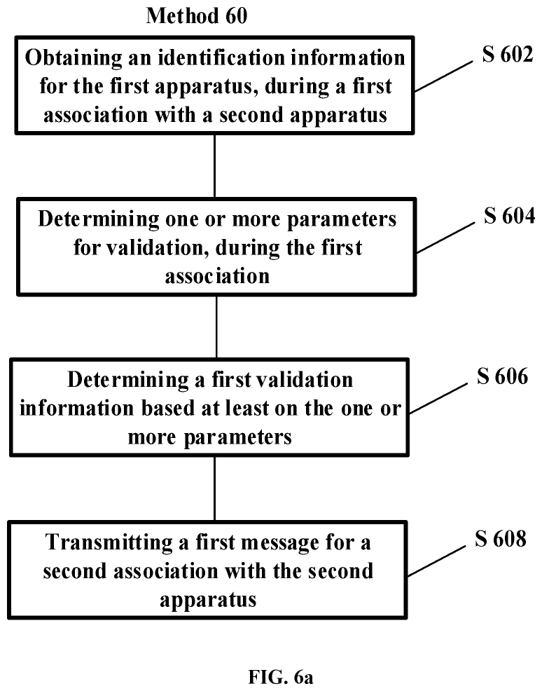

FIG. 5 is a diagram showing the attacker acting as the non-AP STA or the AP.

After attacker obtains legitimate non-AP STA's device identification information (e.g., ID or RMA), it can act like non-AP STA or AP. In both cases, because the attacker has the non-AP STA's device identification information (e.g., ID or RMA), it can use them to impersonate a legitimate non-AP STA or AP as shown in FIG. 5.

Some examples of the attacks are illustrated as follows.

If the attacker imitates a non-AP STA,
Attacker can send Probe Request to discover the network, and AP would not understand that this request comes from the attacker (for AP, if a non-AP STA carries the previously assigned device identification information (e.g., ID or RMA), it is considered legitimate non-AP STA). AP then would reply to this Probe Request with Probe Response, resulting in exposing information (such as information elements (IE) carrying network information) to the attacker (note that 802.11REVme_D1.3.pdf defines at least 111 IE for Probe Response).
Attacker can send Authentication and Association frames to start the association procedure, and AP would accept these request (by sending authentication and association responses) because the attacker carries device identification information (e.g. ID or RMA), resulting in unveiling network-related information (such as network's capabilities and security information) and key generation-related information (such as PMK).
Attacker can send 4-way Handshake (HS) frames to complete the association procedure and start data communication. Even though the attacker would not have the password of the network and get rejected by the AP (incorrect password) despite the attacker uses device identification information (e.g., ID or RMA) (note that a STA needs to use correct password to complete 4-way HS), using device identification information (e.g. ID or RMA) would result in some of 4-way HS message exchanges, exposing key generation-related information (such as PTK). Also note that rejection by the incorrect password takes place in 4-way HS, meaning that attacks by Probe/Authentication/Association request remains valid even the attacker does not use correct password.

If the attacker imitates AP:
Attacker can send beacon frames, and a legitimate non-AP STA would think the AP is a genuine AP, and non-AP STA would start the connection procedure with the attacker.
Attacker can send Probe Response, Authentication Response, Association Response, and 4-way Handshake messages to the non-AP STA in response to Probe Request, Authentication Request, Association Request, and 4-way Handshake messages, and non-AP STA would not understand that these response frames come from the attacker therefore continue to do these frame exchanges, resulting in attacker obtaining critical information (discussed in previous paragraph).

As mentioned above, when a non-AP STA and/or AP uses pre-assigned device identification information (e.g., single or multiple ID or RMA) for the purpose of identification, an attacker might copy and use the non-AP STA's and/or AP's device identification info (obtained through (1) intercepting the frames which exchange device identification info or (2) sniffing and copying frames which carry device identification info) to impersonate a legitimate non-AP STA or AP. It is recalled that pre-association frames (probe, authentication, association, action and part of 4-way HS) are more susceptible to attacks due to lack of security establishment between non-AP STA and AP. As a result, the attacker can initiate some attacks mentioned above. To mitigate these kinds of attacks, non-AP STA and AP need to make sure (validate) that the broadcast (e.g. Broadcast Probe Request, Beacon, Some Broadcast Action frames) and/or unicast management frames (e.g., Directed Probe, Authentication/Association/Action) come from a validated STA (non-AP STA or AP).

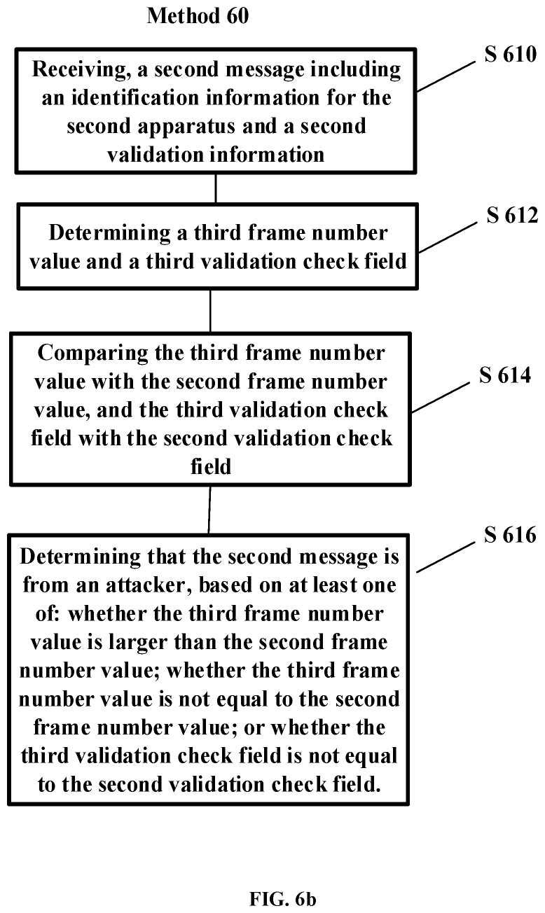

FIG. 6a is a flow chart showing a method performed by a first apparatus, according to exemplary embodiments of the present disclosure.

As shown in FIG. 6a, the method 60 may comprise: a step S602, obtaining an identification information for the first apparatus, during a first association with a second apparatus; a step S604, determining one or more parameters for validation, during the first association; a step S606, determining a first validation information based at least on the one or more parameters; and a step S608, transmitting a first message for a second association with the second apparatus. The first message includes the identification information for the first apparatus and the first validation information.

According to embodiments of the present disclosure, the validation information of an apparatus may be provided in a frame. Thus, an illegal apparatus may be further distinguished. Particularly, the validation information is generated based on one or more specific parameters for validation, which are determined during a first association between a first apparatus and a second apparatus. Therefore, it is hard for an attacker to pretend to be the first or second apparatus in other association procedures.

In exemplary embodiments of the present disclosure, the identification information comprises at least one of: an identifier, ID, or a random media access control address, RMA.

In exemplary embodiments of the present disclosure, the one or more parameters for validation comprises at least one of: a secret key shared by the first apparatus and the second apparatus, a first initial frame number value and a second initial frame number value. The first initial frame number value is the same as the second initial frame number value, or is different than the second initial frame number value. The first initial frame number value is for frames sent from the first apparatus to the second apparatus, and the second initial frame number value is for frames sent from the second apparatus to the first apparatus.

In exemplary embodiments of the present disclosure, at least one of the first and second initial fame number value has a fixed value, and is shared between the first apparatus and the second apparatus privately; or at least one of the first and second initial frame number value has a random value, and is shared publicly.

For example, the first and second initial frame number values can be configured or a random number which could be determined based on certain rule, e.g., generate based on the secret or public key. If it is configured (fixed value), it is shared secretly. If it is random value, it is shared publicly.

In exemplary embodiments of the present disclosure, the first validation information comprises a first frame number value and a first validation check field. The first apparatus runs a first counter to determine the first frame number value, based on the first initial frame number value and a number of frames transmitted from the first apparatus to the second apparatus before the first message, or the first initial frame number value and the number of frames exchanged by the first apparatus and the second apparatus before the first message. The first validation check field is determined based at least on the secret key, using a formula shared between the first apparatus and the second apparatus.

In exemplary embodiments of the present disclosure, the first validation check field is determined further based on the first frame number value.

In exemplary embodiments of the present disclosure, the first validation check field is determined further based on additional data related to at least one of: the first message, the first apparatus, or the second apparatus. The additional data comprises at least one of: public information, private information. The public information comprises at least one of: a field in media access control header, a public key, a public ID, a random number or a public signature. The private information comprises at least one of: a private key, a private ID, a private signature, or a random number.

According to embodiments of the present disclosure, it will be very hard for an attacker to generate the validation information.

In exemplary embodiments of the present disclosure, the first frame number value and the first validation information are encrypted in the first message.

In exemplary embodiments of the present disclosure, the first message comprises a unicast management frame, or a broadcast management frame.

In exemplary embodiments of the present disclosure, the first message comprises at least one of: probe request, authentication frame sent from first apparatus, association request or action frames. The action frames may be such as public action frame, FTM request.

In exemplary embodiments of the present disclosure, the action frames may be such as public action frame, FTM request, etc.

In some embodiments, the 4-way handshake frames may not carry validation information. The 4-way handshake frames may carry device identification.

According to embodiments of the present disclosure, such validation information may be used widely, and thus may protect legitimate apparatus in very scenarios.

FIG. 6b is a flow chart illustrating additional steps of the method performed by the first apparatus, in accordance with some embodiments of the present disclosure.

As shown in FIG. 6b, the method 60 may further comprise: a step S610, receiving, a second message including an identification information for the first and/or second apparatus and a second validation information. The second validation information comprises a second frame number value and a second validation check field.

In exemplary embodiments of the present disclosure, the method 60 may further comprise: a step S612, determining a third frame number value and a third validation check field; a step S614, comparing the third frame number value with the second frame number value, and the third validation check field with the second validation check field; and a step S616, determining that the second message is from an attacker, based on at least one of: whether the third frame number value is larger than the second frame number value, wherein the third frame number value is determined based on a frame number value successfully received in a previous frame; whether the third frame number value is not equal to the second frame number value, wherein the third frame number value is determined based on the second initial frame number value and a number of frames exchanged by the first apparatus and the second apparatus before the second message; or whether the third validation check field is not equal to the second validation check field. The third frame number value is determined by the first counter based on a frame number value successfully received in a previous frame, or the second initial frame number value and a number of frames exchanged by the first apparatus and the second apparatus before the first message. The third validation check field is determined based on at least one of: the secret key or the third frame number value, using a formula shared between the first apparatus and the second apparatus.

According to embodiments of the present disclosure, a specific manner for distinguishing attacking messages may be provided.

In exemplary embodiments of the present disclosure, the second frame number value and the second validation information are encrypted in the second message.

In exemplary embodiments of the present disclosure, the second message comprises a unicast management frame.

In exemplary embodiments of the present disclosure, the second message comprises at least one of: probe response, authentication frame sent from the second apparatus, association response, or action frames.

In exemplary embodiments of the present disclosure, the action frames may be such as public action frame, FTM request, etc.

In some embodiments, the 4-way handshake frames may not carry validation information.

In exemplary embodiments of the present disclosure, the first apparatus comprises a non access point station, non-AP STA, or an access point, AP, in a wireless local area network operating according to a standard of 802.11. The second apparatus comprises an AP, or a non-AP STA, in the wireless local network.

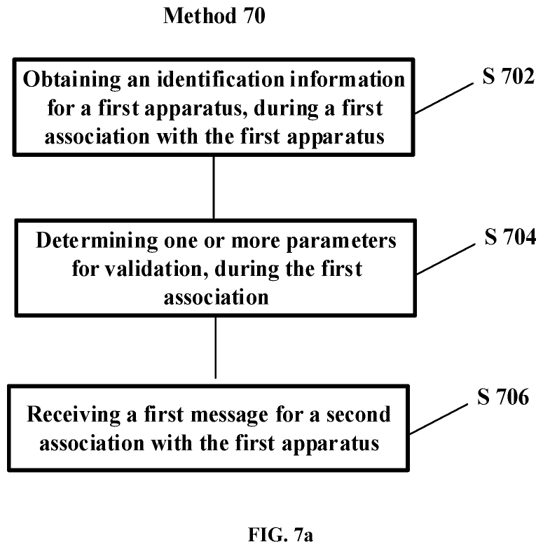

FIG. 7a is a flow chart showing a method performed by a second apparatus, according to exemplary embodiments of the present disclosure.

As shown in FIG. 7a, the method 70 may comprise: a step S702, obtaining an identification information for a first apparatus, during a first association with the first apparatus; a step S704, determining one or more parameters for validation, during the first association; and a step S706, receiving a first message for a second association with the first apparatus. The first message includes the identification information for the first apparatus and a first validation information.

In exemplary embodiments of the present disclosure, the identification information comprises at least one of: an identifier, ID, or a random media access control address, RMA.

In exemplary embodiments of the present disclosure, the one or more parameters for validation comprises at least one of: a secret key shared by the first apparatus and the second apparatus, a first initial frame number value and a second initial frame number value. The first initial frame number value is the same as the second initial frame number value, or is different than the second initial frame number value. The first initial frame number value is for frames sent from the first apparatus to the second apparatus, and the second initial frame number value is for frames sent from the second apparatus to the first apparatus.

In exemplary embodiments of the present disclosure, at least one of the first and second initial fame number value has a fixed value, and is shared between the first apparatus and the second apparatus privately; or at least one of the first and second initial frame number value has a random value, and is shared publicly. In exemplary embodiments of the present disclosure, the first validation information comprises a first frame number value and a first validation check field.

FIG. 7b is a flow chart illustrating additional steps of the method performed by the second apparatus, in accordance with some embodiments of the present disclosure.

As shown in FIG. 7b, the method 70 may further comprise: a step S708, determining a fourth frame number value and a fourth validation check field; a step S710, comparing the fourth frame number value with the first frame number value, and the fourth validation check field with the first validation check field; and a step S712, determining that the first message is from an attacker, based on at least one of: whether the fourth frame number value is larger than the first frame number value, wherein the fourth frame number value is determined based on a frame number value successfully received in a previous frame; whether the fourth frame number value is not equal to the first frame number value, wherein the fourth frame number value is determined based on the first initial frame number value and a number of frames exchanged by the first apparatus and the second apparatus before the first message; or whether the fourth validation check field is not equal to the first validation check field. The fourth frame number value is determined by a second counter based on a frame number value successfully received in a previous frame, or the first initial frame number value and a number of frames exchanged by the first apparatus and the second apparatus before the first message. The fourth validation check field is determined based at least on the secret key, using a formula shared between the first apparatus and the second apparatus.

In exemplary embodiments of the present disclosure, the fourth validation check field is determined further based on the fourth frame number value.

In exemplary embodiments of the present disclosure, the fourth validation check field is determined further based on additional data related to at least one of: the first message, the first apparatus, or the second apparatus. The additional data comprises at least one of: public information, private information. The public information comprises at least one of: a field in media access control header, a public key, a public ID, a random number, or a public signature. The private information comprises at least one of: a private key, a private ID, a private signature, or a random number.

In exemplary embodiments of the present disclosure, the first frame number value and the first validation information are encrypted in the first message.

In exemplary embodiments of the present disclosure, the first message comprises a unicast management frame, or a broadcast management frame.

In exemplary embodiments of the present disclosure, the first message comprises at least one of: probe request, authentication frame sent from first apparatus, association request, or action frames. The action frames may be such as public action frame, FTM request.

FIG. 7c is a flow chart illustrating additional steps of the method performed by the second apparatus, in accordance with some embodiments of the present disclosure.

In exemplary embodiments of the present disclosure, the method 70 may further comprise: a step S714, transmitting, a second message including an identification information for the first and/or second apparatus and a second validation information. The second validation information comprises a second frame number value and a second validation check field. The second apparatus runs a second counter to determine the second frame number value, based on the second initial frame number value and a number of frames transmitted from the second apparatus to the first apparatus before the second message, or the second initial frame number value and a number of frames exchanged by the first apparatus and the second apparatus before the second message. The second validation check field is determined based on at least one of: the secret key, or the second frame number value, using a formula shared between the first apparatus and the second apparatus.

In exemplary embodiments of the present disclosure, the second frame number value and the second validation information are encrypted in the second message.

In exemplary embodiments of the present disclosure, the second message comprises a unicast management frame, or a broadcast management frame.

In exemplary embodiments of the present disclosure, the second message comprises at least one of: probe response, authentication frame sent from the second apparatus, association response, or action frames.

In exemplary embodiments of the present disclosure, the first apparatus comprises a non access point station, non-AP STA, or an access point, AP, in a wireless local area network operating according to a standard of 802.11. The second apparatus comprises an access point, AP, or a non-AP STA, in the wireless local network.

According to embodiments of the present disclosure, STA and AP each gets identifier (e.g., ID or RMA). STA or AP use their own identifier (e.g., ID or RMA).

When there is an attack (impersonate STA or AP), STA should validate the frames coming from real AP, AP should validate the frames come from STA. To achieve that, FN+VC (IE) is used in unicast (from STA to AP, from AP to STA) and broadcast management (from STA to everyone, from AP to everyone frames.

A secret key (VK) is defined between each STA and AP, and is stored at STA and AP for future use.

For unicast management frames, a unique VK should be determined for each STA-AP pair.

For broadcast management frames, a single VK should be determined for all STA-AP pairs (basically, one single key for all STAs and AP).

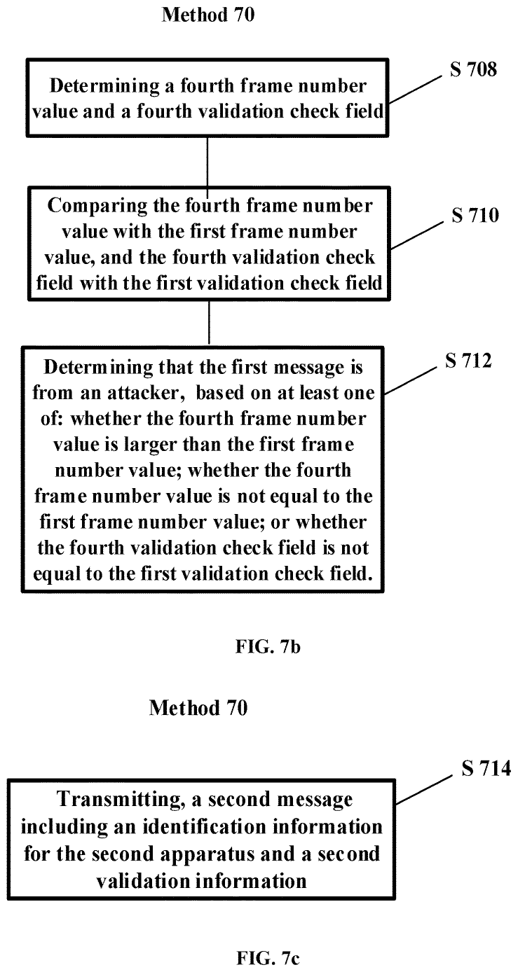

FIG. 8a is a block diagram showing an exemplary structure for the first apparatus, according to exemplary embodiments of the present disclosure.

As shown in FIG. 8a, the first apparatus 80 comprises means 800 configured for: obtaining an identification information for the first apparatus, during a first association with a second apparatus; determining one or more parameters for validation, during the first association; determining a first validation information based at least on the one or more parameters; and transmitting a first message for a second association with the second apparatus. The first message includes the identification information for the first apparatus and the first validation information.

In exemplary embodiments of the present disclosure, the means 800 are further configured for performing the method according any of the embodiments in the first aspect, such as shown in FIG. 6a, 6b.

In exemplary embodiments of the present disclosure, the means 800 comprise: at least one processor 802; and at least one memory 804 storing instructions that, when executed by the at least one processor 802, cause the performance of the first apparatus 80.

FIG. 8b is a block diagram showing an exemplary structure for the second apparatus, according to exemplary embodiments of the present disclosure.

As shown in FIG. 8b, a second apparatus 81 comprises means 810 configured for: obtaining an identification information for a first apparatus, during a first association with the first apparatus; determining one or more parameters for validation, during the first association; and receiving a first message for a second association with the first apparatus. The first message includes the identification information for the first apparatus and a first validation information.

In exemplary embodiments of the present disclosure, the means 810 are further configured for performing the method according any of the embodiments in the second aspect, such as shown in FIG. 7a, 7b, 7c.

In exemplary embodiments of the present disclosure, the means 810 comprise: at least one processor 812; and at least one memory 814 storing instructions that, when executed by the at least one processor 812, cause the performance of the second apparatus 81.

The processor 802, 812 may be any kind of processing component, such as one or more microprocessor or microcontrollers, as well as other digital hardware, which may include digital signal processors (DSPs), special-purpose digital logic, and the like. The memory 804, 814 may be any kind of storage component, such as read-only memory (ROM), random-access memory, cache memory, flash memory devices, optical storage devices, etc.

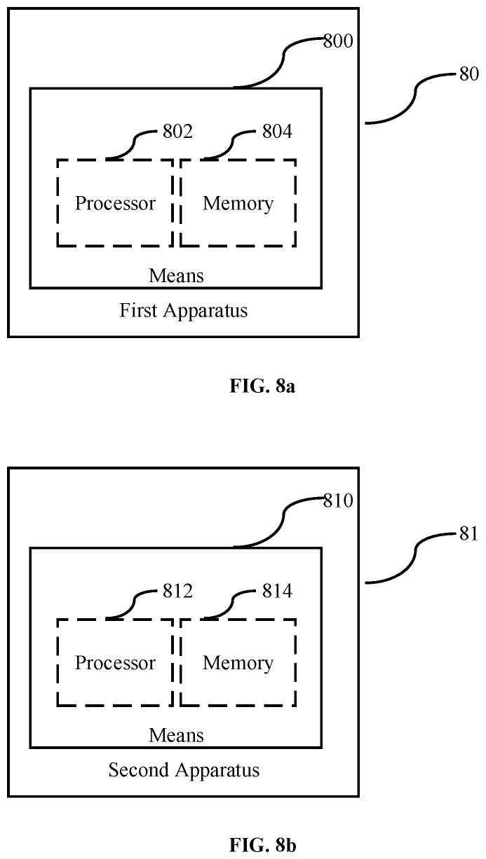

FIG. 9 is a block diagram showing an apparatus/computer readable storage medium, according to embodiments of the present disclosure.

As shown in FIG. 9, a computer-readable storage medium 90 storing instructions 91, which when executed by at least one processor of a first apparatus, cause the at least one processor of the first apparatus to perform the method according to any of the embodiments of the first aspect, such as shown in FIG. 6a, 6b; or when executed by at least one processor of a second apparatus, cause the at least one processor of the second apparatus to perform the method according to any of the embodiments of the second aspect, such as shown in FIG. 7a, 7b, 7c.

In addition, the present disclosure may also provide a carrier containing the computer program/instructions as mentioned above. The carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

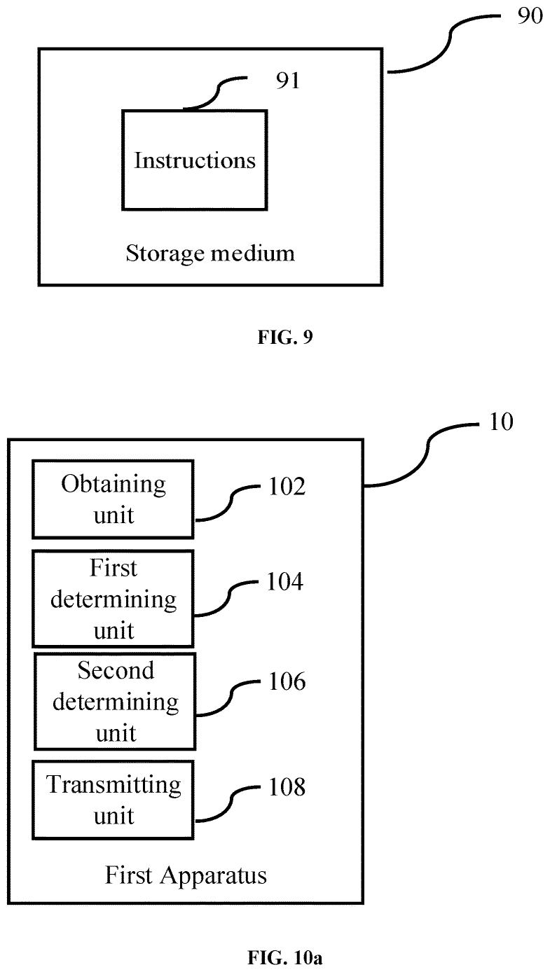

FIG. 10a is a block diagram showing exemplary apparatus units for the first apparatus, which is suitable for performing the method according to embodiments of the disclosure.

As shown in FIG. 10a, the first apparatus 10 may include a obtaining unit 102, configured for obtaining an identification information for the first apparatus, during a first association with a second apparatus; a first determining unit 104, configured for determining one or more parameters for validation, during the first association; a second determining unit 106, configured for determining a first validation information based at least on the one or more parameters; and a transmitting unit 108, configured for transmitting a first message for a second association with the second apparatus. The first message includes the identification information for the first apparatus and the first validation information.

In exemplary embodiments of the present disclosure, the first apparatus 10 is further configured for performing the method according any of the embodiments in the first aspect, such as shown in FIG. 6a, 6b.

FIG. 10b is a block diagram showing exemplary apparatus units for the second apparatus, which is suitable for performing the method according to embodiments of the disclosure.

As shown in FIG. 10b, the second apparatus 11 may include an obtaining unit 112, configured for obtaining an identification information for a first apparatus, during a first association with the first apparatus; a determining unit 114, configured for determining one or more parameters for validation, during the first association; and a receiving unit 116, configured for, receiving a first message for a second association with the first apparatus. The first message includes the identification information for the first apparatus and a first validation information.

In exemplary embodiments of the present disclosure, the second apparatus 11 is further configured for performing the method according any of the embodiments in the first aspect, such as shown in FIG. 7a, 7b, 7c.

The term ‘unit’ may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

As used in the present disclosure, the term “circuitry” may refer to one or more or all of the following:
(a) hardware-only circuit implementations (such as implementations in only analogy and/or digital circuitry) and
(b) combinations of hardware circuits and software, such as (as applicable):
   (i) a combination of analogy and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in the present disclosure, including in any claims. As a further example, as used in the present disclosure, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

With these units, the apparatus may not need a fixed processor or memory, any kind of computing resource and storage resource may be arranged from at least one network node/device/entity/apparatus relating to the communication system. The virtualization technology and network computing technology (e.g., cloud computing) may be further introduced, so as to improve the usage efficiency of the network resources and the flexibility of the network.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function, or means that may be configured to perform two or more functions. For example, these techniques may be implemented in hardware (one or more apparatuses), firmware (one or more apparatuses), software (one or more modules/units), or combinations thereof. For a firmware or software, implementation may be made through modules (e.g., procedures, functions, and so on) that perform the functions described herein.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionalities may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

The term “non-transitory,” as used herein, is a limitation of the medium itself (i.e., tangible, not a signal) as opposed to a limitation on data storage persistency (e.g., RAM vs. ROM).

As described in above exemplary embodiments of this disclosure, a legitimate STA (non-AP STA or AP) may be the STA that had a successful association (between non-AP STA and AP) and exchanged a valid device identification information (e.g., ID or RMA), and is able to use that device identification information (e.g., ID or RMA) in later association(s).

To achieve the validation, embodiments of the present disclosure propose to define an Information element (IE) containing at least Frame Number (FN) and Validation Check (VC) to be used in unicast (e.g., Probe Messages, Authentication Messages, Association Messages, Action Messages etc.) and broadcast (e.g., Broadcast Probe Request, Beacon etc.) management frames. As example but not limitation, embodiments of the present disclosure use the name “Validation Information Element (VIE)” for the proposed Information Element.

In short, when a non-AP STA first associates with the AP (ESS), non-AP STA and/or AP gets a device identification information (e.g., ID or RMA). During this first association, the non-AP STA and AP (ESS) also determine a secret key to be used for Validation Information Element (VIE). In later association(s), the non-AP STA sends the unicast management frames (e.g. Probe/Authentication/Association/Action requests) and broadcast management frames (e.g. Broadcast Probe Request) with its own VIE, and AP sends the unicast management frames (e.g. Probe/Authentication/Association/Action responses) and broadcast management frames (e.g. Beacon) with its own VIE. By doing so, even if the attacker uses the non-AP STA's and/or AP's device identification information (e.g., ID or RMA), non-AP STA and AP can check the VIE and recognize the attacker.

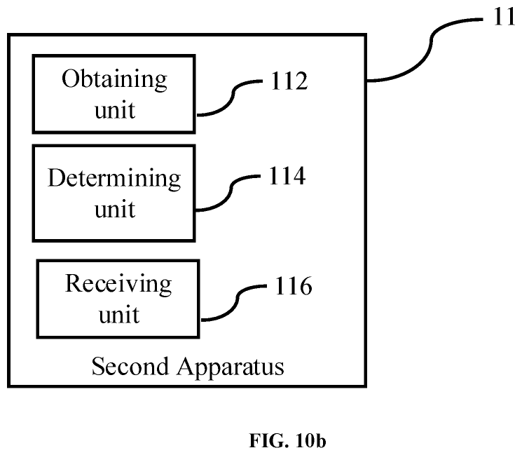

FIG. 11 is a diagram showing a proposed Information element (Validation Information Element (VIE)) usage and validating if the frames come from the validated STA or an attacker.

As shown in FIG. 11, the main steps between the non-AP STA and the AP of the embodiments of the present disclosure can include following steps.

In step 1, non-AP STA first associates with the AP (ESS) and non-AP STA and/or AP gets a device identification information (e.g., ID or RMA).

In step 2, during the first association, non-AP STA and AP determine a secret key to be used for proposed Validation Information Element (VIE). Note that for unicast management frames, the secret key is determined for each non-AP STA and AP pair, or for all non-AP STAs and AP pairs, while for broadcast management frames, the same single secret key is determined for one or more non-AP STAs and AP. Therefore, there can be two secret keys. A secret key may be for unicast management frames and 4-way HS frames, another secret key may be for broadcast management frames.

For example, the secret key can be determined as follows.

In stage 1), one side generates and sends the secret key to the other side—(like IGTK in WiFi). For example, the AP generates secret key=123 and sends it to STA. For example, STA generates secret key=123 and sends it to AP.

In stage 2), each side uses another key to generate the same secret key.

For example, STA and AP have another key (such as PTK), and they derive the secret key based on this key (PTK).

In stage 3), one side sends extra information to the other side to generate the secret key.

For example, AP sends random value (such as a Nonce) to STA, STA generates the secret key based on this random value (Nonce).

It should be noted that, the key derivation function can be any standard function in 802.11 or non-standard function other than 802.11.

One example function may be that: secret key=HMAC-SHA256 (PTK, MAC address).

Namely, the secret key is calculated based on a method of HMAC-SHA256, and the input parameters may include a PTK, and a MAC address.

Further the validation information may be generated by a function using a secret key, additional data, or/and FN.

For example, VC=HMAC-SHA256 (secret key, FN, additional data); or VC=HMAC-SHA256 (secret key, additional data).

For usage related to broadcast management frame, the secret key may be shared by one or more multiple STAs, especially which could be the stored key, like stored IGTK.

In step 3, in later association(s) (e.g., second association), non-AP STA and/or AP uses previously assigned device identification information (e.g., ID or RMA). Non-AP STA sends its own Validation Information Element (VIE) in unicast management frames (e.g., probe, authentication, association requests, action frames) and broadcast management frames (e.g. Broadcast Probe Request). AP checks received Validation Information Element (VIE) in received unicast and broadcast frames and makes sure (validates) that the frames come from a validated STA (i.e., non-AP STA), not from an attacker that uses non-AP STA's device identification information (e.g., ID or RMA).

In step 4, upon validating the non-AP STA, AP sends its own Validation Information Element (VIE) in unicast management frames (e.g., probe, authentication, association responses, action frames) and broadcast management frames (e.g. Beacon). Non-AP STA checks received Validation Information Element (VIE) in received unicast and broadcast management frames and makes sure (validates) that the frames come from a validated STA (i.e., AP).

In embodiments of the present disclosure, validation happens by checking VIE's Frame Number (FN) if there is replay attack (FN value increases by one in each acknowledged unicast management frame) and VIE's Validation Check (VC) if the transmitter's VC and receiver's VC match.

In embodiments of the present disclosure, each side (non-AP STA and AP) may require keeping two counters for FN values; one for request frames, one for response frames.

According to embodiments of the present disclosure, there may be following advantages. With Validation Information Element (VIE), AP (ESS) can validate the non-AP STA from pre-association unicast management request frames (e.g., probe/authentication/association/action requests).

Further, non-AP STA can validate the AP from pre-association unicast management response frames (e.g., probe/authentication/association/action responses).

Further, based upon validation, an attacker (imitating a non-AP STA or AP) can be recognized immediately.

Embodiments of the present disclosure propose to define an Information element (IE) called “Validation Information Element (VIE)” containing at least Frame Number (FN) and Validation Check (VC) fields to be used in unicast management frames (e.g., Probe Messages, Authentication Messages, Association Messages, Action Messages etc.) and broadcast management frames (e.g. Broadcast Probe Request, Beacon etc.) to validate a STA (non-AP STA or AP) when using device identification information (e.g. ID or RMA) for identification purposes, resulting in recognizing the attacker when the attacker uses non-AP STA's and/or AP's device identification information (e.g., ID or RMA). In this context, the attacker can impersonate non-AP STA or AP.

The frame format and usage of the Validation Information Element (VIE) (containing Frame Number (FN) and Validation Check (VC) fields) for unicast and broadcast management frames may be illustrated below. An example is given to show the VIE definition for Probe Request.

The construction and transmission & reception of Validation Information Element (VIE) will be illustrated below.

Further, examples how to detect the attacker with the help of VIE when the attacker uses non-AP STA's and/or AP's device identification information (e.g., ID or RMA) will be also illustrated.

In some exemplary embodiments of the present disclosure, each side (STA or AP) may keep its own FN value. FN can be fixed initial value (shared secretly). FN can be random (shared publicly).

In some other exemplary embodiments of the present disclosure, both sides keep single FN value. FN can be fixed initial value (shared secretly). FN can be random (shared publicly, like Unicast).

In some exemplary embodiments of the present disclosure, VC is calculated based on secret key (VK).

In some exemplary embodiments of the present disclosure, VC input parameter does not include FN. In some other exemplary embodiments of the present disclosure, VC input parameter includes FN.

VC input parameter may include additional data such as MAC address, keyID, etc., MAC header fields, Nonce, seed, etc.

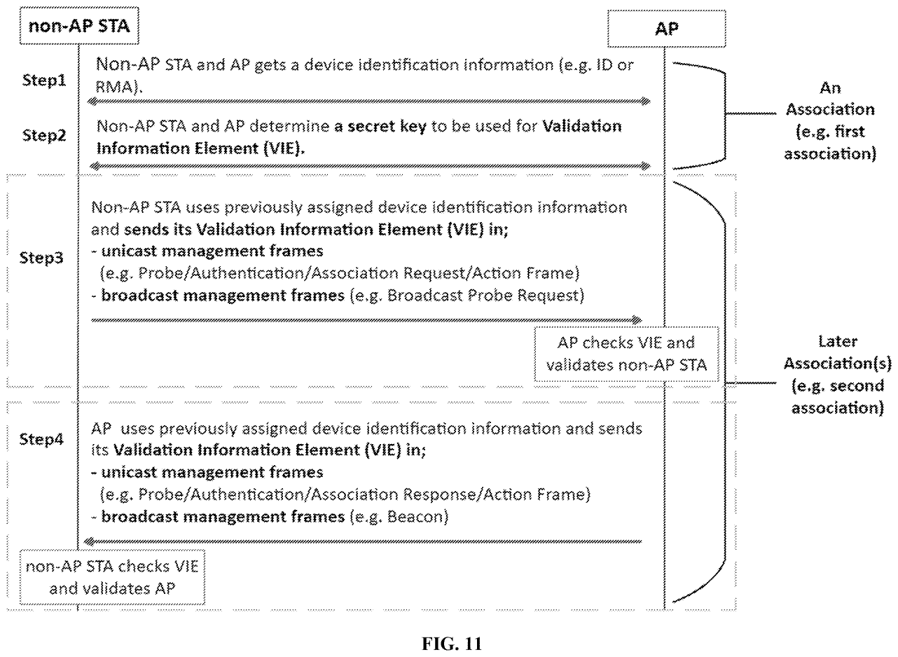

FIG. 12 is a diagram showing an example of Validation Information Element (VIE) and its fields-Frame Number (FN) and Validation Check (VC).

As to an example of the validation Information Element (VIE) frame format, Validation Information Element (VIE) may contain at least two fields, namely, Frame Number (FN) and Validation Check (VC) as shown in FIG. 12.

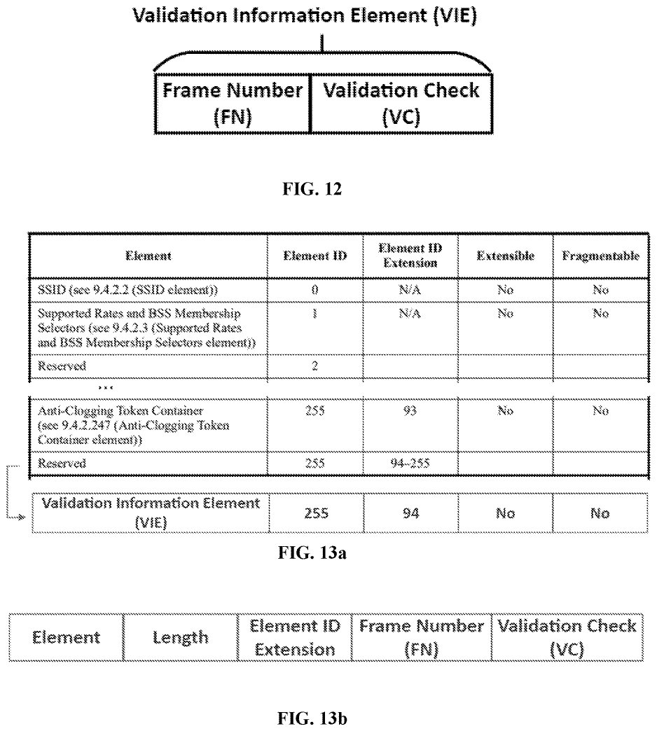

FIG. 13a is a diagram showing an example for Validation Information Element (VIE) Definition, according to embodiments of the present disclosure.

FIG. 13b is a diagram showing an example for Validation Information Element (VIE) Format, according to embodiments of the present disclosure.

The current 802.11REVme_D1.3 defines several Information Elements (see Table 9-128-Element IDs in 802.11REVme_D1.3). As shown in FIG. 13a, 13b, the proposed Validation Information Element (VIE) may be Element ID=255, Element ID Extension=94, Extensible=No, Fragmentable=No. This IE may have many fields, such as element, length element ID extension, frame number, and validation check.

In another embodiment, VIE can contain other fields in addition to FN and VC fields, for example, ID field (such as key ID) and initial FN value.

As to Validation Information Element (VIE) in unicast and broadcast management frames, validation Information Element (VIE) can be defined for many unicast and broadcast management frames including Beacon, Directed Probe Request, Broadcast Probe Request, Probe Response, Authentication frames, Association Messages, Re-Association Messages, Action frames. To show an example to define the VIE for a unicast management frame, defining the VIE for Probe Request frame may be illustrated. Any other unicast and broadcast management frame can be defined in the same or similar manner.

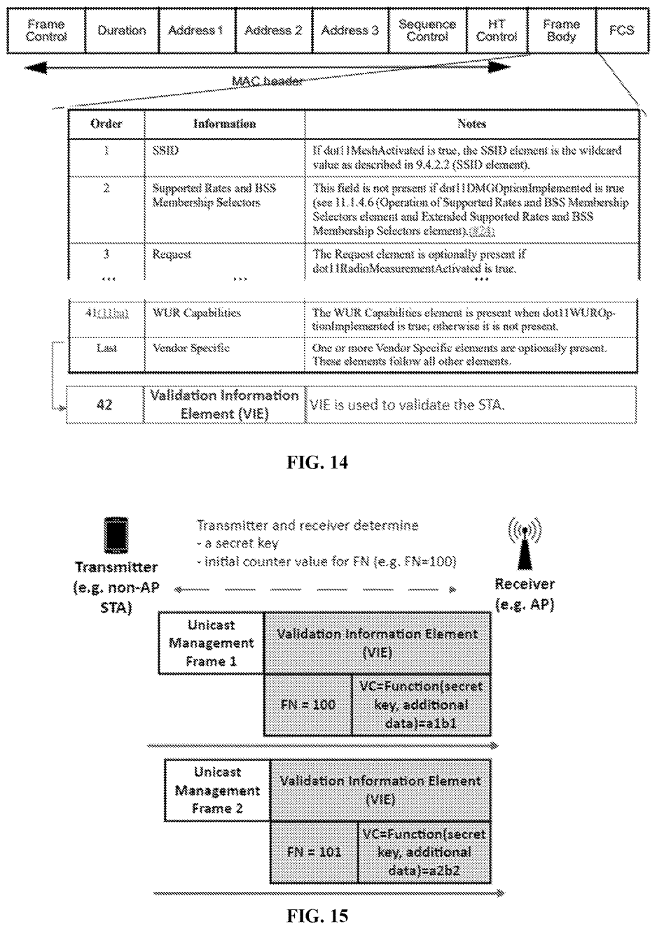

FIG. 14 is a diagram showing the proposed Validation Information Element (VIE) in Probe Request, according to embodiments of the present disclosure.

The current 802.11REVme_D1.3 defines 41 items in probe request frame body (see table 9.66 in 802.11REVme_D1.3). As shown in FIG. 14, as to an example of validation Information Element (VIE) in Probe Request, the proposed Validation Information Element (VIE) order may be Order=42. This field carries at least Frame Number (FN) and Validation Check (VC) of Validation Information Element (VIE) for validating the STA.

Examples for construction and Transmission & Reception of Validation Information Element (VIE) may be further illustrated.

Validation Information Element (VIE) contains at least two fields, namely: Frame Number (FN) and Validation Check (VC) as shown in FIG. 12.

Frame Number (FN) may be used for replay protection, and it may be a monotonically increasing non-negative integer in each broadcast management frame and acknowledged unicast management frame.

The procedure for FN may be defined as follows.

1—The receiver should keep a receive replay counter.

2—The receiver should set the receive replay counter, to the value of the FN.

3—The transmitter should set a monotonically increasing non-negative integer to the FN field every time it sends unicast and/or broadcast management frame.

4—The receiver receives a frame and should compare the FN value in the received frame against the receive replay counter. If the received FN value is less than or equal to the replay counter value, the receiver shall ignore the frame.

For validation Check (VC), it may be a cryptographic value derived based on a secret key (along with additional data) negotiated between non-AP STA and AP.

The procedure for VC is defined as follows:

1—The transmitter should calculate VC value based on the secret key negotiated between non-AP STA and AP (along with some other additional information) using an encryption function, and sends it to the receiver.

2—The receiver receives the frame and saves the received VC value.

3—The receiver then computes its own VC value and compares it with the received VC value. If they match, the receiver accepts the frame, otherwise, discards.

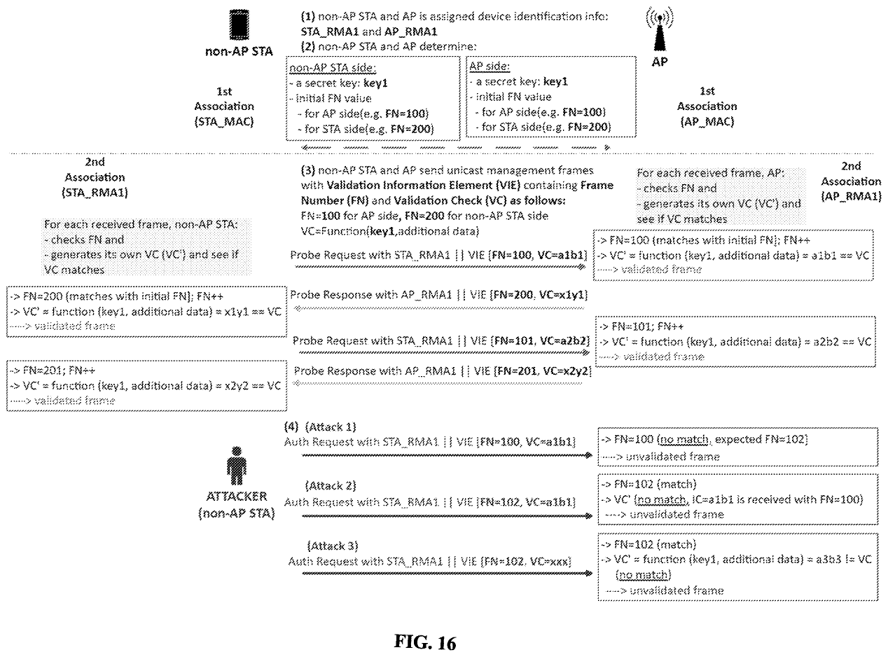

FIG. 15 is a diagram showing an example scenario to construct VIE.

Transmitter (e.g., non-AP STA) and Receiver (e.g., AP) determine a secret key and initial counter value for FN. The key is used to generate VC field. When transmitter sends the first unicast management frame, it inserts the negotiated initial FN value (100 in FIG. 15) and calculated VC value (a1b1 in FIG. 15) into VIE. In each unicast management frame, transmitter increases the FN value (FN=101 for second unicast management frame), while receiver keeps track of the FN value to perform replay protection. Also, in each frame the new VC value in inserted into VIE (VC=a2b2 for second unicast management frame). It should be noted that such validation information may be also used in broadcast management frames.

In one embodiment, the FN and VC values can be encrypted again to increase protection. As an example, transmitter and receiver can use a hash function based on another secret key to encrypt FN and VC values. In that case, for instance, the original FN value (100) becomes hashed FN value (say, 697), and the original VC value (a1b1) becomes hashed VC value (say, aBcD). Since only transmitter and receiver have the key for hash, only they can decrypt these fields to the original values.

In another embodiment, transmitter and receiver may set up an initial value for FN field for replay counter.

In another embodiment, one of the input parameters of the VC generation function can be FN value.

In another embodiment, additional data for VC generation may include at least public information (such as fields in MAC header, public key, public ID, public signature) and private information (such as private key, private ID, private signature).

As to example of detecting the attacker via the usage of Validation Information Element (VIE), informative implementation of the usage of VIE and detection of the attacker may be illustrated. In this regard, following example may be given.

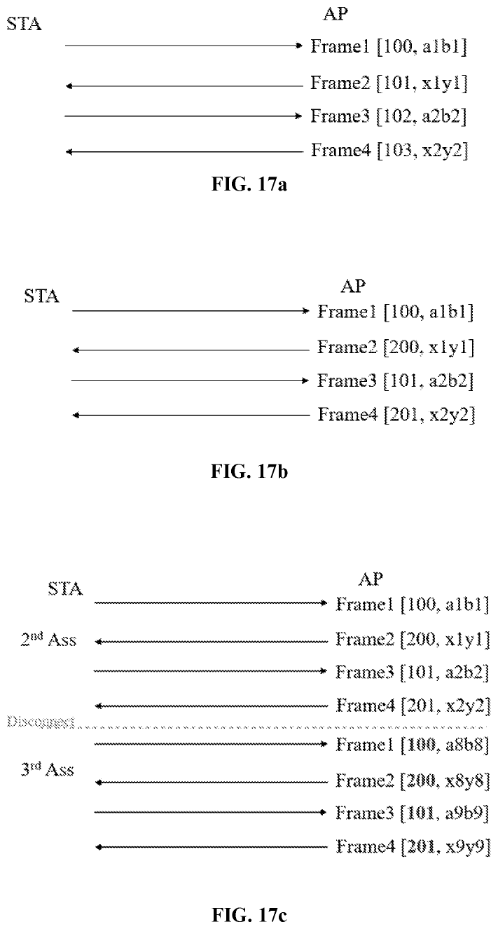

FIG. 16 is a diagram showing an example scenario of VIE [FN, VC] usage and attacker detection, according to embodiments of the present disclosure.

For illustration but not limitation, the example scenario (as illustrated in FIG. 16) may include following steps, mainly about unicast management frames. However, it should be noted that such validation information may be also used in broadcast management frames.

In Step1: Non-AP STA associates (in a first association) with its STA_MAC address to the AP with AP_MAC, and is assigned with a device identification info: STA_RMA1. AP is also assigned with device identification info: AP_RMA1.

In Step2: Non-AP STA and AP determine a secret key (key1) and two initial Frame Number (FN) values (FN=100 for AP side, FN=200 for STA side). key1, FN=100 and FN=200 are not disclosed outside of the non-AP STA and the AP.

Non-AP STA disconnects after a while.

In Step3: Non-AP STA wants to associate (in a second association) with AP again using previously assigned (from first association) device identification info (STA_RMA1). AP is also using its own device identification info AP_RMA1 in second association.

In a substep I. Non-AP STA starts sending unicast management frames (e.g., Probe Request) with its device identification info (STA_RMA1) and Validation Information element (VIE).

To construct VIE, Non-AP STA starts Frame Number (FN) field with 100 (previously determined initial value), and increases it by one for each frame (101, 102 etc.) Non-AP STA generates Validation Check (VC) field based on previously determined secret key (key1) and additional data. The VC field is re-generated in each frame as well.

As an example, the first probe request frame is [FN=100, VC-a1b1]. The second probe request frame is [FN=101, VC-a2b2].

In a substep II. For each received unicast management frame (probe request), AP checks FN and VC field.

For FN, AP knows the initial value (100). It means, it expects the initial FN field of the initial frame to be 100, and the next FN field to be 101. For VC, AP generates its own VC field (called VC′) and checks if this value matches the VC value of the received frame. Note that since AP has the same secret key (key1) and uses the same formula as non-AP STA, it can generate the same VC field. If the values match, AP recognizes that the frames come from a validated non-AP STA.

In the example, AP receives first probe request frame with [FN=100, VC=a1b1]. FN matches with initial determined value. AP also generates its own VC value VC′=a1b1 based on the secret key (key1), which matches with the received VC-a1b1. Therefore, first probe request is considered valid.

AP also sends its unicast management frame (i.e. first probe response) with its own VIE. In this example, VN is constructed as [FN=200, VC=x1y1] for the first probe response frame. After non-AP STA receives this frame, it checks the FN and VC value, and determines that it is a valid frame.

AP receives the second probe request frame is [FN=101, VC=a2b2]. Similarly, FN of the received frame matches with the counter value of AP. Also, AP's generated VC value (VC′=a2b2) also matches with the VC field of received frame. This frame is also considered valid. Besides, AP also sends second probe response with [FN=201, VC=x2y2], and this frame is determined valid at non-AP side.

In Step4: the attacker listens to the probe request frames from non-AP STA and figures out non-AP STA's device identification info (STA_RMA1). At this moment, the attacker uses non-AP STA's device identification info (STA_RMA1) to send authentication request to the AP. In this context as an example, three possible attacks are possible.

In an attack 1, the attacker sends exactly the same probe request (with the same FN and VC fields, i.e. [FN=100, VC=a1b1]) as non-AP STA sent before.

When AP receives this frame, it realizes that received frame is using FN=100. This value is used before (by non-AP STA), therefore, AP rejects this authentication request (unvalidated frame). It is noted that AP expects a unicast management frame with FN=102 according to its counter.

In an attack 2, the attacker sends the correct FN number [FN=102] that AP expects (note that attacker can listen to the unicast management frames (e.g., probe request) sent from non-AP STA and figure out the correct FN value if the FN value is not protected, as it is the case in this example) and previously used (first probe for example) VC value [VC=a1b1].

When AP receives this frame, the FN value of the received frame matches. However, the VC vale of this received frame [VC=a1b1] is used with FN=100 before (by non-AP STA).

Therefore, AP rejects this authentication request (unvalidated frame).

In an attack 3, the attacker sends the correct FN number [FN=102] that AP expects (note that attacker can listen to the unicast management frames sent from non-AP STA and figure out the correct FN value if the FN value is not protected, as it is the case in this example) and self-generated VC value [VC=xxx].

When AP receives this frame, the FN value of the received frame matches. However, the VC vale of this received frame [VC=xxx] does not match with the VC value that the AP generates (VC′). Since VC fails, AP reject this authentication request (unvalidated frame). It is noted that since the attacker does not know the secret key (key1) and/or the calculation formula, it is almost impossible for attacker to generate VC that would match AP's VC (VC′).

For example, to improve the privacy and security, the secret key and/or the calculation formula can be designed as very hard (such as, rather long and/or complexity) to be obtained or to be decrypted by an attacker.

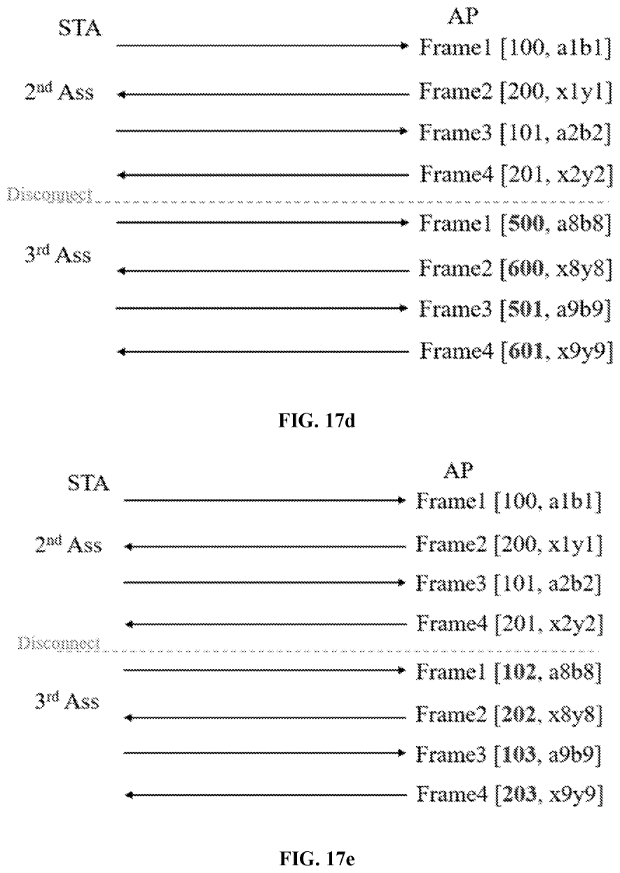

FIG. 17a is a diagram showing a first example scenario about the increasement of the frame number value.

As shown in FIG. 17a, the same initial frame number value “100” is used for frames from both of the first and second apparatus. The frame number will increase with each of transmitted frame. Therefore, the Frame 1 (from STA) has a frame number 100, the Frame 2 (from AP) has a frame number 101, the Frame 3 (from STA) has a frame number 102, the Frame 4 (from AP) has a frame number 103.

Further, each frame may include a particular validation check field as shown in FIG. 17a.

FIG. 17b is a diagram showing a second example scenario about the increasement of the frame number value.

As shown in FIG. 17b, the first initial frame number value “100” is used for frames from STA, and the second initial frame number value “200” is used for frames from AP. The frame number will increase with each of transmitted frame. Therefore, the Frame 1 (from STA) has a frame number 100, the Frame 2 (from AP) has a frame number 200, the Frame 3 (from STA) has a frame number 101, the Frame 4 (from AP) has a frame number 201.

Further, each frame may include a particular validation check field as shown in FIG. 17b.

FIG. 17c is a diagram showing a third example scenario about the increasement of the frame number value.

As shown in FIG. 17c, in a second association (Ass), the first initial frame number value “100” is used for frames from STA, and the second initial frame number value “200” is used for frames from AP. The frame number will increase with each of transmitted frame. Therefore, the Frame 1 (from STA) has a frame number 100, the Frame 2 (from AP) has a frame number 200, the Frame 3 (from STA) has a frame number 101, the Frame 4 (from AP) has a frame number 201.

Then, a disconnect may happen between STA and AP.

The initial frame number values will reset as in the previous connection.

Therefore, in a third association, the Frame 1 (from STA) has a frame number 100, the Frame 2 (from AP) has a frame number 200, the Frame 3 (from STA) has a frame number 101, the Frame 4 (from AP) has a frame number 201.

Further, each frame may include a particular validation check field as shown in FIG. 17c.

FIG. 17d is a diagram showing a fourth example scenario about the increasement of the frame number value.

As shown in FIG. 17d, in a second association (Ass), the first initial frame number value “100” is used for frames from STA, and the second initial frame number value “200” is used for frames from AP. The frame number will increase with each of transmitted frame. Therefore, the Frame 1 (from STA) has a frame number 100, the Frame 2 (from AP) has a frame number 200, the Frame 3 (from STA) has a frame number 101, the Frame 4 (from AP) has a frame number 201.

Then, a disconnect may happen between STA and AP.

The initial frame number values will reset as being different as in the previous connection, which may be 500, 600.

Therefore, in a third association, the Frame 1 (from STA) has a frame number 500, the Frame 2 (from AP) has a frame number 600, the Frame 3 (from STA) has a frame number 501, the Frame 4 (from AP) has a frame number 601.

Further, each frame may include a particular validation check field as shown in FIG. 17d.

FIG. 17e is a diagram showing a fifth example scenario about the increasement of the frame number value.

As shown in FIG. 17e, in a second association (Ass), the first initial frame number value “100” is used for frames from STA, and the second initial frame number value “200” is used for frames from AP. The frame number will increase with each of transmitted frame. Therefore, the Frame 1 (from STA) has a frame number 100, the Frame 2 (from AP) has a frame number 200, the Frame 3 (from STA) has a frame number 101, the Frame 4 (from AP) has a frame number 201.

Then, a disconnect may happen between STA and AP.

The initial frame number values and the current frame number values may be not reset, but may be stored.

Therefore, continuously, in a third association, the Frame 1 (from STA) has a frame number 102, the Frame 2 (from AP) has a frame number 202, the Frame 3 (from STA) has a frame number 103, the Frame 4 (from AP) has a frame number 203.

Further, each frame may include a particular validation check field as shown in FIG. 17e.

Therefore, according to exemplary embodiments of the present disclosure, non-AP STA and AP should make sure (validate) that the unicast management frames (e.g., Probe Req/Resp, Authentication Req/Resp, Association Req/Resp) come from a validated STA (non-AP STA or AP), so as to avoid messages from attackers. In this context, embodiments of the present disclosure propose to define an Information element (IE) to be used in unicast management frames (e.g., Probe Messages, Authentication Messages, Association Messages, Action Messages etc.) so that the non-AP STA and AP would make sure that these frames come from a validated STA (non-AP STA or AP), avoiding the possible replay and evil twin attacks mentioned. Particularly, the information element may contain at least Frame Number (FN) and Validation Check (VC).

It should be understood that the above embodiments are only for illustration but not limitation. The present disclosure may be carried out in other ways than those specifically set forth herein without departing from essential characteristics of the disclosure. All changes to these embodiments not departing from the meaning and equivalency of the appended claims are intended to be comprised herein.

### REFERENCES

802.11REVme_D1.3, referring to: IEEE P802.11-REVme™/D1.3, June 2022, Draft Standard for Information technology-Telecommunications and information exchange between systems Local and metropolitan area networks-Specific requirements/D1.3, June 2022, Part 11: Wireless LAN Medium Access Control (MAC) and Physical Layer (PHY) Specifications, Prepared by the 802.11 Working Group of the LAN/MAN Standards Committee of the IEEE Computer Society
[22/187r2], referring to: IEEE 802.11-22/0187r2, Network generated Device ID, Date: 2022 Mar. 10, Jouni Malinen, Qualcomm
[22/925r2], referring to: IEEE 802.11-22/0925r2, Proposed Text for MAAD for TGbh Draft 0.2, Date: 2022 July, Graham SMITH (SRT Wireless)
[22/895r1], referring to: IEEE 802.11-22/0895r1, Proposed Text for Identifiable Random MAC, IRM-3, Date: 2022 June, Graham SMITH (SRT Wireless)
[22/888r2], referring to: IEEE 802.11-22/0888r2, Rule-based random MAC STA identification (RRCM), Date: 2022 Jun. 12, Orhan Okan Mutgan, Nokia, etc.
[22/158r3], referring to: IEEE 802.11-22/0158r3, STA generated Device ID, Date: 2022 Feb. 8, Jouni Malinen, Qualcomm, Inc.
[22/114r3], referring to: IEEE 802.11-22/0114r3, Enhanced Randomized and Changing MAC address (ERCM), Date: 2022 May 10, Stéphane Baron, Canon, etc.

| ABBREVIATION | EXPLANATION |
|---|---|
| AP | Access Point |
| FTM | Fine Timing Measurement |
| IE | Information Element |
| PMK | Pairwise Master Key |
| PTK | Pairwise Transient Key |
| RCM | Random and Changing MAC |
| RMA | Random MAC Address |
| STA | Station |
| ESS | Extended Service Set |
| MAAD | MAC Address Designation |
| IRMA | Identifiable Random MAC Address |
| RRCM | Rule-based Random and Changing MAC Address |
| FN | Frame Number |
| VC | Validation Check |
| VIE | Validation Information Element |
| 4-way HS | 4-way Handshake |
| ID | Identifier |
| IGTK | Integrity Group Temporal Key |

1-39. (canceled)

40. A first apparatus, comprising:
at least one processor; and
at least one memory storing instructions that, when executed by the at least one processor, cause the apparatus to:
obtain an identification information for the first apparatus, during a first association with a second apparatus;
determine one or more parameters for validation, during the first association;
determine a first validation information based at least on the one or more parameters; and
transmit a first message for a second association with the second apparatus;
wherein the first message comprises the identification information for the first apparatus and the first validation information.

41. The first apparatus according to claim 40,
wherein the identification information comprises at least one of: an identifier, ID, or a random media access control address, RMA.

42. The first apparatus according to claim 40,
wherein the one or more parameters for validation comprises at least one of: a secret key shared by the first apparatus and the second apparatus, or a first initial frame number value and a second initial frame number value;
wherein the first initial frame number value is the same as the second initial frame number value, or is different than the second initial frame number value; and
wherein the first initial frame number value is for frames sent from the first apparatus to the second apparatus, and the second initial frame number value is for frames sent from the second apparatus to the first apparatus.

43. The first apparatus according to claim 42,
wherein at least one of the first and second initial frame number value has a fixed value, and is shared between the first apparatus and the second apparatus privately: or
wherein at least one of the first and second initial frame number value has a random value, and is shared publicly.

44. The first apparatus according to claim 42,
wherein the first validation information comprises a first frame number value and a first validation check field;
wherein the first apparatus runs a first counter to determine the first frame number value, based on the first initial frame number value and a number of frames transmitted from the first apparatus to the second apparatus before the first message, or the first initial frame number value and a number of frames exchanged by the first apparatus and the second apparatus before the first message;
wherein the first validation check field is determined based at least on the secret key, using a formula shared between the first apparatus and the second apparatus.

45. The first apparatus according to claim 44,
wherein the first validation check field is determined further based on the first frame number value.

46. The first apparatus according to claim 44,
wherein the first validation check field is determined further based on additional data related to at least one of the first message, the first apparatus, or the second apparatus;
wherein the additional data comprises at least one of: public information, private information;
wherein the public information comprises at least one of: a field in media access control header, a public key, a public ID, a random number, or a public signature; and
wherein the private information comprises at least one of: a private key, a private ID, a private signature, or a random number.

47. The first apparatus according to claim 44,
wherein the first frame number value and the first validation information are encrypted in the first message.

48. The first apparatus according to claim 40,
wherein the first message comprises a unicast management frame, or a broadcast management frame.

49. The first apparatus according to claim 48,
wherein the first message comprises at least one of: probe request, authentication frame sent from first apparatus, association request, or action frames.

50. A method performed by a first apparatus, comprising:
obtaining an identification information for the first apparatus, during a first association with a second apparatus;
determining one or more parameters for validation, during the first association;
determining a first validation information based at least on the one or more parameters; and
transmitting a first message for a second association with the second apparatus;
wherein the first message comprises the identification information for the first apparatus and the first validation information.

51. A second apparatus, comprising:
at least one processor; and at least one memory storing instructions that, when executed by the at least one processor, cause the apparatus to:
obtain an identification information for a first apparatus, during a first association with the first apparatus;
determine one or more parameters for validation, during the first association; and
receive a first message for a second association with the first apparatus;
wherein the first message comprises the identification information for the first apparatus and a first validation information.

52. The second apparatus according to claim 51,
wherein the identification information comprises at least one of: an identifier, ID, or a random media access control address, RMA.

53. The second apparatus according to claim 51,
wherein the one or more parameters for validation comprises at least one of: a secret key shared by the first apparatus and the second apparatus, or a first initial frame number value and a second initial frame number value;
wherein the first initial frame number value is the same as the second initial frame number value, or is different than the second initial frame number value; and
wherein the first initial frame number value is for frames sent from the first apparatus to the second apparatus, and the second initial frame number value is for frames sent from the second apparatus to the first apparatus.

54. The second apparatus according to claim 53,
wherein at least one of the first and second initial fame number value has a fixed value, and is shared between the first apparatus and the second apparatus privately: or
wherein at least one of the first and second the initial frame number value has a random value, and is shared publicly.

55. The second apparatus according to claim 53,
wherein the first validation information comprises a first frame number value and a first validation check field.

56. The second apparatus according to claim 54, wherein the at least one processor; and the at least one memory storing instructions that, when executed by the at least one processor, further cause the first apparatus to:
determine a fourth frame number value and a fourth validation check field;
compare the fourth frame number value with the first frame number value, and the fourth validation check field with the first validation check field; and
determine that the first message is from an attacker, based on at least one of: whether the fourth frame number value is larger than the first frame number value, wherein the fourth frame number value is determined based on a frame number value successfully received in a previous frame; whether the fourth frame number value is not equal to the first frame number value, wherein the fourth frame number value is determined based on the first initial frame number value and a number of frames exchanged by the first apparatus and the second apparatus before the first message: or whether the fourth validation check field is not equal to the first validation check field;
wherein the fourth frame number value is determined by a second counter based on a frame number value successfully received in a previous frame, or the first initial frame number value and a number of frames exchanged by the first apparatus and the second apparatus before the first message; and
wherein the fourth validation check field is determined based at least on the secret key, using a formula shared between the first apparatus and the second apparatus.

57. The second apparatus according to claim 56,
wherein the fourth validation check field is determined further based on the fourth frame number value.

58. The second apparatus according to claim 56,
wherein the fourth validation check field is determined further based on additional data related to at least one of: the first message, the first apparatus, or the second apparatus;
wherein the additional data comprises at least one of: public information, private information;
wherein the public information comprises at least one of: a field in media access control header, a public key, a public ID, a random number, or a public signature; and
wherein the private information comprises at least one of: a private key, a private ID, a private signature, or a random number.

59. The second apparatus according to claim 54, wherein the first frame number value and the first validation information are encrypted in the first message.
